(19) United States
(12) Patent Application Publication
(10) Pub. No.: US 2019/0245850 A1
(43) Pub. Date: Aug. 8, 2019

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/121,238

(22) Filed: Sep. 4, 2018

(30) Foreign Application Priority Data
Feb. 2, 2018 (JP) 2018-017266

(51) Int. Cl. H04L 29/06; H04L 29/08

(52) U.S. Cl. CPC H04L 63/0861; H04L 67/306

(57) ABSTRACT

An information processing device includes a controller that controls an authentication of an account with a service capable of fulfilling a request of a user, the request being specifiable from a received voice of the user.

### CROSS-REFERENCE TO RELATED APPLICATIONS

This application is based on and claims priority under 35 USC 119 from Japanese Patent Application No. 2018-017266 filed Feb. 2, 2018.

### BACKGROUND

### (i) Technical Field

The present disclosure relates to an information processing device and a non-transitory computer readable medium.

### (ii) Related Art

Recently, speakers with built-in voice assistant functions, commonly referred to as “smart speakers” or the like, have appeared on the market. A smart speaker is able to respond to user questions, execute processes such as playing music, and control the behavior of Internet of Things (IoT) equipment. There are also smart speakers capable of being shared among multiple users by preregistering information (such as a user's voice) related to the multiple users.

Examples of the related art are described in Japanese Unexamined Patent Application Publication No. 2013-149238, Japanese Unexamined Patent Application Publication No. 2017-162129, Japanese Patent No. 6111186, and Japanese Patent No. 5942503, for example.

### SUMMARY

Aspects of non-limiting embodiments of the present disclosure relate to fulfilling a user's request specifiable from voice in conjunction with account information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a controller that controls an authentication of an account with a service capable of fulfilling a request of a user, the request being specifiable from a received voice of the user.

### BRIEF DESCRIPTION OF THE DRAWINGS

An exemplary embodiment of the present disclosure will be described in detail based on the following figures, wherein:

FIG. 1 is an overall configuration diagram of a conversation server system according to the present exemplary embodiment;

FIG. 2 is a block configuration diagram of a smart speaker according to the present exemplary embodiment;

FIG. 3 is a diagram illustrating an example of the data structure of user management information set and registered in user management information storage according to the present exemplary embodiment;

FIG. 4 is a flowchart illustrating a service access process according to the present exemplary embodiment;

FIG. 5 is a diagram schematically illustrating the content of a dialogue between a user and a smart speaker; and

FIG. 6 is a diagram illustrating a correspondence table between service types and services stored in a smart speaker according to the present exemplary embodiment.

### DETAILED DESCRIPTION

Hereinafter, a suitable exemplary embodiment of the present disclosure will be described on the basis of the drawings.

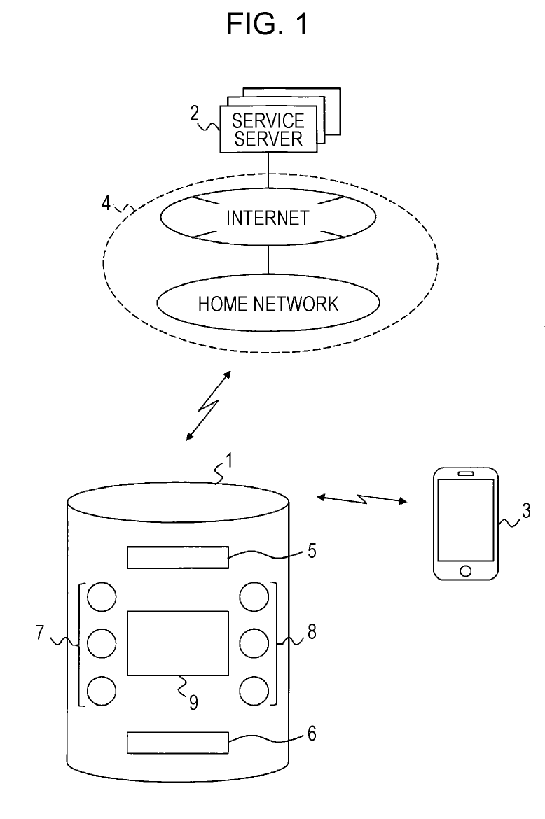

FIG. 1 is an overall configuration diagram of a conversation server system including a smart speaker according to the present exemplary embodiment. FIG. 1 illustrates a smart speaker 1, a service server 2, a user terminal 3, and a network 4.

Specifically, the network 4 includes at least a home network and the Internet. The home network is a network constructed inside the building where the smart speaker 1 is placed. The smart speaker 1 communicates data with the service server 2 through the home network and the Internet. In the case in which IoT equipment such as home appliances are installed in the building, the smart speaker 1 communicates data with the IoT equipment through the home network. “IoT equipment” refers to any type of device connected to the Internet.

The smart speaker 1 is commonly installed indoors, and is a speaker with built-in voice assistant functions capable of obtaining various information through the network 4 to respond to spoken questions from the user, and also capable of controlling the behavior of IoT equipment. In other words, the speaker is controllable by voice alone. Such a smart speaker is also called an “AI speaker” in some cases.

The smart speaker 1 has a built-in computer (information processing device) equipped with a CPU, ROM, RAM, and a storage unit, while in addition, a speaker 5 and a microphone 6 are also provided. Also, as illustrated in FIG. 1, indicators 7 and 8 as well as a liquid crystal panel 9 may also be provided. Additionally, although not illustrated, other components such as a camera may also be provided. The speaker 5 is a sound output unit, and outputs processing results, responses, and the like as sound with respect to questions from the user. The speaker 5 also plays music or the like in accordance with a demand from the user. The microphone 6 is a sound input unit, and receives spoken questions from the user. Although FIG. 1 schematically illustrates only a single microphone 6, multiple microphones may also be provided to enable accurate recognition of voices emitted from any direction, or to enable specification of the position of the speaking user.

The indicators 7 and 8 are light emitters for informing the user of some kind of information by light. For example, by using a lighting (blinking) pattern, the indicators 7 may be used to inform the user of bot settings or the like, while the indicators 8 may be used to inform the user of a recognized speaking person. The method of using the indicators 7 and 8 described above is one example, and it is sufficient to set the lighting (blinking) patterns and the emitted colors of the indicators 7 and 8 at certain positions appropriately to conform to the usage conditions of the smart speaker 1. Also, if the smart speaker 1 is equipped with a display such as a liquid crystal panel, account information may also be displayed on the display.

Note that a “bot” refers to a application that executes an automated task, and is provided in the smart speaker 1. Bots as well as other dedicated applications corresponding to services are installed in the smart speaker 1.

The liquid crystal panel 9 is a display that displays information, the content of responses, and the like to be reported to a recognized speaking person. Also, by realizing the display with a touch panel, the display may also be configured to double as an operation unit.

The service server 2 is a server computer that provides services to users via the Internet. The provided services are, for example, services provided by accessing the website of a business that provides various services, such as electronic commerce (e-commerce) websites and search engine websites. The provided services may also be cloud services provided by a cloud server. In the present exemplary embodiment, a computer that provides a service to the user of the smart speaker 1 is designated the “service server” 2, irrespectively of what service is provided.

The user terminal 3 is a terminal device used by a user whose account is set and registered in the smart speaker 1. The user terminal 3 stores personal information, including information related to services for which the user has registered an account, such as account information (such as an account ID and a password) used to log in to services, for example, information used to purchase products, such as credit card information, and the like. The user terminal 3 is realized by a device such as a personal computer (PC), a tablet PC, a mobile PC, a smartphone, or a mobile phone. In the present exemplary embodiment, the user terminal 3 is described as being a smartphone in which a dedicated application for using the smart speaker 1 is installed.

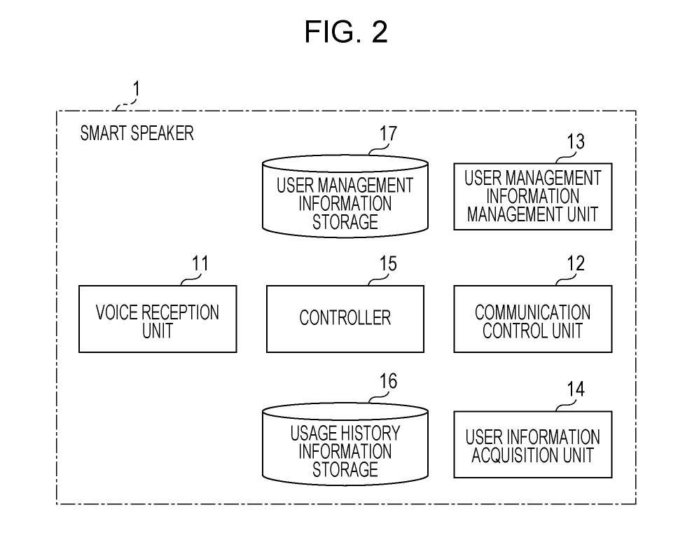

FIG. 2 is a block configuration diagram of the smart speaker 1 according to the present exemplary embodiment. The smart speaker 1 according to the present exemplary embodiment includes a voice reception unit 11, a communication control unit 12, a user management information management unit 13, a user information acquisition unit 14, a controller 15, usage history information storage 16, and user management information storage 17. Note that structural elements not used in the description of the present exemplary embodiment are omitted from FIG. 1.

The voice reception unit 11 receives voice input from the microphone 6. The communication control unit 12 controls communication with the service server 2 via the network 4 and wireless communication with the user terminal 3. The communication control unit 12 communicates wirelessly with the user terminal 3 in accordance with a communication scheme supported by the user terminal 3, such as infrared communication, visible light communication, Wi-Fi (registered trademark) communication, or short-range wireless communication (such as near field communication (NFC), for example), for example. The communication control unit 12 controls data communication with the user terminal 3 directly or through the home network in correspondence with the communication scheme being used. Additionally, the communication control unit 12 controls data communication with IoT equipment.

The user management information management unit 13 manages user management information stored in the user management information storage 17, such as by registering, modifying, and removing information. The user information acquisition unit 14 acquires personal information about the user who will use the smart speaker 1 from the user terminal 3 or the like. The controller 15 operates in cooperation with each of the structural elements to execute a function provided by the smart speaker 1. For example, the controller 15 realizes a bot described above by executing a dedicated application, and issues instructions to the service server 2 on the user's behalf. In particular, the controller 15 according to the present exemplary embodiment includes a function of controlling the authentication of an account with a service capable of fulfilling a user's request specifiable from a received voice of the user.

The user uses the smart speaker 1 by asking spoken questions, and the usage history information storage 16 accumulates usage history information including the content of the usage history for that user. The usage history information includes, for example, identification information regarding the user who uses the smart speaker 1, the account information used, information indicating the time of use (such as the start time and duration of use), and information related to the service used (identification information regarding the destination service server 2 or the service, and the content of the service (such as the type, identification information regarding purchased products, purchases, and purchase prices)).

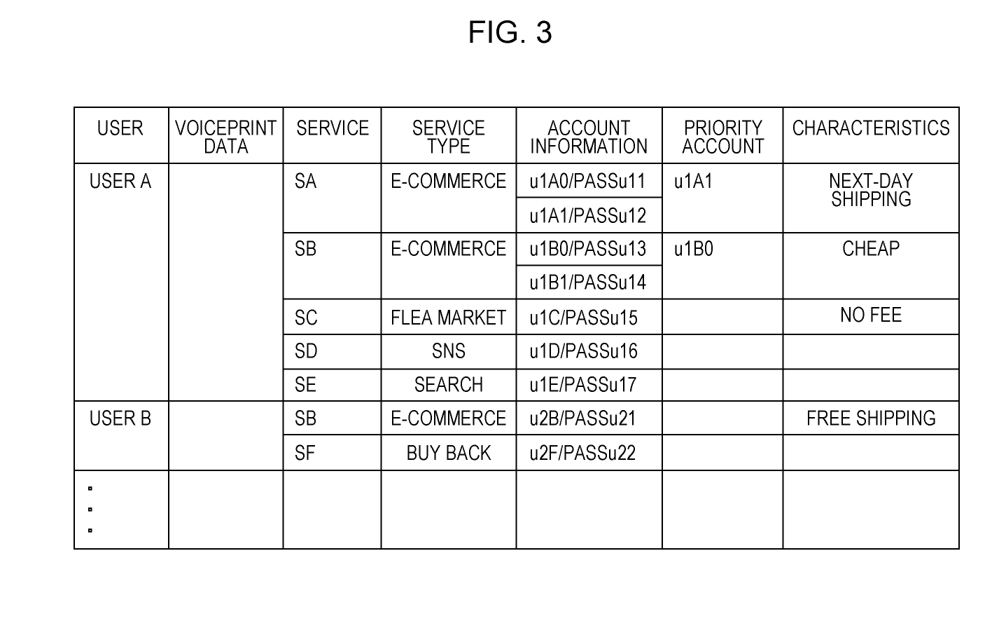

FIG. 3 is a diagram illustrating an example of the data structure of the user management information set and registered in the user management information storage 17 according to the present exemplary embodiment. FIG. 3 illustrates the user management information in table format. In the user management information, information is generated for each user who uses the smart speaker 1. The user management information includes individual data fields for the user, voiceprint data, service, service type, account information, priority account, and characteristics. “User” is identification information regarding a user who uses the smart speaker 1. “Voiceprint data” is voiceprint data used for voiceprint authentication of the user, and is registered during the initial setup of the smart speaker 1. “Voiceprint data” may also be saved in a storage location other than the user management information, in accordance with the specifications of the smart speaker 1. In this case, information about the storage location of the voiceprint data is set in the “Voiceprint data” field.

The user uses the smart speaker 1 to use various services, and in the “Service” field, a designation for the service (service name) that acts as information (one or more terms) specifying the service is set. In many cases, the service is specified by the name of the business that provides the service. Consequently, in the “Service” field, a business name may be set as the designation for the service (service name), and the service may be specified by the business name. The controller 15 in the smart speaker 1 specifies an access destination according to the setting in the “Service” field. In the smart speaker 1, a web browser for accessing a website (service server 2) of a service business specified by a service name, and where appropriate, a dedicated application for the service are preinstalled.

In the “Service type” field, the type of the above service is set. Types of services include e-commerce services that sell products, flea market services where products (used goods) and the like are bought and sold, search services, buy-back services, and the like. In the “Account information” field, account information used to log in to (be authenticated by) the service is set, in which at least an account ID and a password of the user for the service are set. Some services allow a single user to register multiple accounts, and in the case in which a single user has registered multiple accounts with such a service, a “Priority account” for setting which account to prioritize for use is set. In other words, in the “Priority account” field, only a single account that the user wants to prioritize for use is set, as exemplified in FIG. 3. Alternatively, a priority ranking may be set for each account registered with respect to the service. In the “Characteristics” field, characteristics of the service are set.

In FIG. 3, for example, the pair of the service “SB” and the account information “u2B/PASSu21” as well as the pair of “SF” and the account information “u2F/PASSu22” are set with respect to a user B. In this way, accounts for multiple services may be registered with respect to a single user. Also, for example, the services “SA” and “SB” are set in correspondence with the service type “E-commerce” for a user A. In this way, the accounts of different services belonging to the same type may also be registered. Also, the account information “u1A0/PASSu11” and the account information “u1A1/PASSu12” are set with respect to the service “SA” for the user A. In this way, multiple accounts may be registered with respect to the same service.

Each of the structural elements 11 to 15 in the smart speaker 1 is realized by the cooperative action between the computed provided in the smart speaker 1 and a program running on the CPU of the computer. Also, each storage area 16 and 17 is realized by the storage unit provided in the smart speaker 1. Alternatively, RAM may be used, or an external storage unit may be used over a network. It is possible to provide the program used in the present exemplary embodiment via a communication medium.

For a user who uses a service, various personal information, such as payment information, is set in one's own account for the service in some cases. Consequently, even in the case of using a service through the smart speaker 1 shared by multiple users, it is thought that each user expects to use the service by logging in with one's own account, rather than with an account shared among the multiple users. Also, even in the case in which a single user has registered multiple accounts with respect to a single service, the user may want to use the accounts differently depending on the usage scenario or the product to purchase in some cases.

Accordingly, a feature of the present exemplary embodiment is the ability to control the authentication of an account with a service capable of fulfilling a request of the user (the user who wants to use the service), the request being specifiable from the received voice of the user. For the user to utilize the account control which is a feature of the present exemplary embodiment, user management information regarding the user is set and registered in advance in the user management information storage 17. Hereinafter, the setting and registration (initial registration) of the user management information in the user management information storage 17 performed by the user management information management unit 13 will be described.

The user downloads a dedicated application for the smart speaker 1 to the user terminal 3, and uses the dedicated application to register one's voice in the smart speaker 1. With this arrangement, the user becomes able to use the smart speaker 1 by performing user registration with the smart speaker 1.

The user management information management unit 13 registers the registered voice (voiceprint data) in the user management information storage 17. Alternatively, information about the storage location of the voiceprint data is registered. Note that the initial setup of the smart speaker 1, such as linking to the home network, is unrelated to the present exemplary embodiment, and thus a description is omitted.

Next, the user management information management unit 13 displays an information registration screen for setting the user management information on the user terminal 3, and causes the user to set the user management information. In other words, the user is made to set one or more services the user wants to utilize by using the smart speaker 1, the type of the service, account information (an account ID and password) used to log in to the service, and in the case of registering multiple accounts for a single service, the priority account. First, typical services may be listed in a pull-down menu, and the user may be made to select a service from the list, or perform character input. Subsequently, the user is made to set account information registered with the service. It is preferable to list selectable service types in a pull-down menu, and cause the user to select the service type from the list.

Meanwhile, the service business that provides the service with which a user account is registered may provide multiple types of services in some cases. Even a service business that mostly focuses on an e-commerce service may also provide a buy-back service in some cases. Even a service business that mostly focuses on a search service may also provide an SNS service in some cases. Consequently, it is sufficient for the user to set in the “Service type” field the one or more types of service the user wants to use from among the multiple services provided by the service business set in the “Service” field. Consequently, multiple “service types” may also be set with respect to a single service. For example, the user management information may be set such that both a search service and an SNS service provided by the service (service business) “SE” are used.

Additionally, the user sets subjective characteristics with respect to the services. As exemplified in FIG. 3, characteristics such as “next-day shipping” and “cheap” are set. The voiceprint data, the service, and the account information are non-optional input items for using the service itself, but the other fields are optional items which may be omitted in the case of not using the additional functions provided by the present exemplary embodiment described later.

The present exemplary embodiment presupposes that the user is made to set the user management information as above. However, it is also possible for the user management information management unit 13 to set item data automatically with respect to each field of the user management information corresponding to a user registered in the smart speaker 1. For example, the user may download the dedicated application for the smart speaker 1 to the user terminal 3 and use the dedicated application to register one's voice in the smart speaker 1, but other relevant information may be extracted from the user terminal 3 being used for the voice registration. The user management information management unit 13 cooperates with the user information acquisition unit 14 to extract services for which a dedicated application is installed from the user terminal 3. Subsequently, account information for the services saved in the user terminal 3 is extracted and registered in the user management information storage 17. When a service is specified, the type of the service may be specified. Note that the user management information management unit 13 may be configured to set a default service type of the service (service business) automatically in the “Service type” field, or query the user and set the response (service type) obtained thereby. Also, in the case in which the user has multiple registered accounts with a single service, the priority account is set. In this case, it is sufficient to automatically set, for example, the most recent account from among the multiple registered accounts as the priority account. Also, if it is possible to extract a characteristic (sales point) of the service by analyzing the business website, the sales point may be set as a characteristic.

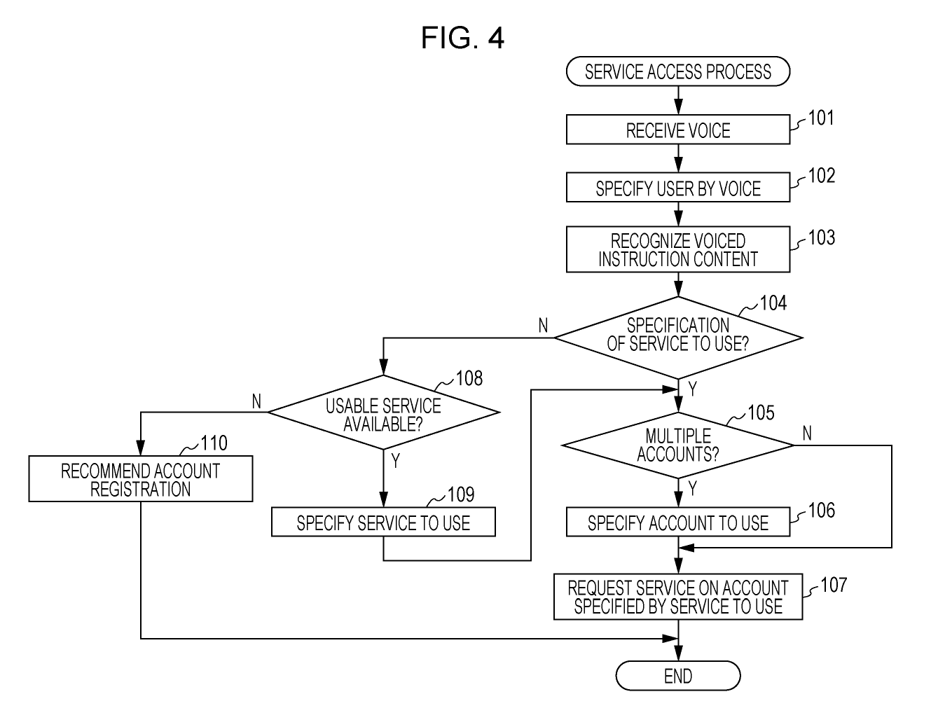

With the above arrangement, the user management information management unit 13 sets information designated by the user as the user management information, or sets the user management information automatically. Instead of selecting whether information is to be set manually by the user or automatically, the setting user management information may also be performed by an appropriate combination of manual and automatic input. With this arrangement, the smart speaker 1 becomes able to allow usage of the service in accordance with a question (voice) from the user. Hereinafter, in the present exemplary embodiment, the flowchart illustrated in FIG. 4 will be used to describe a process for accessing the service server 2 to enable a user to use a service.

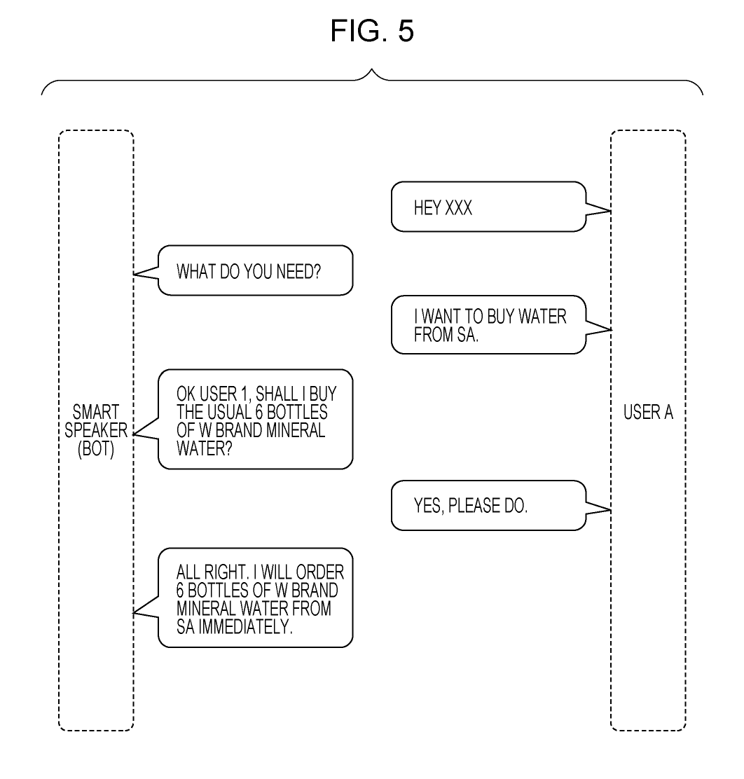

In the case in which the user wants to use a service by voice alone using the smart speaker 1, first, the user calls out to the smart speaker 1. FIG. 5 is a diagram schematically illustrating the content of a dialogue between the user A and the smart speaker 1. Note that in the case in which the smart speaker 1 includes a display, the content of the dialogue illustrated in FIG. 4 may also be displayed on the display to enable the user to check the content of the dialogue.

Because the user A calls out to the smart speaker 1, a dialogue is initiated between the user A and the smart speaker 1. For example, assume that the user A issues the voiced instruction “I want to buy water from SA.” to the smart speaker 1. When the voice reception unit 11 in the smart speaker 1 receives the spoken voice of the user A (step 101), the controller 15 performs voiceprint authentication by checking received voice data against the voiceprint data registered in the user management information, and specifies the user (step 102). In this example, the user A is specified.

Next, the controller 15 recognizes the instruction content by analyzing the voice data (step 103). For the authentication method, it is sufficient to use existing technology. From the analysis of the voice data, the controller 15 recognizes that the service is “SA”, and the request of the user A is “I want to buy water”.

Like this example, in the case in which the user A has designated the service “SA”, or in other words, in the case in which the service that the user A wants to use is included in the voice of the user A (step 104, Y), the controller 15 references the user management information of the user A, and checks whether or not an account is registered with the service. Like the example settings illustrated in FIG. 3, in the case in which information about multiple accounts is set with respect to the service “SA” for the user A (step 105, Y), the controller 15 specifies the account to use in the utilization of the service from among the information about multiple accounts as follows (step 106). Note that in the case in which information about only a single account is set (step 105, N), the controller 15 specifies that account as the account to use in the utilization of the service.

According to the example settings illustrated in FIG. 3, since a priority account is set in the user management information of the user A, the account set as the priority account is used. According to the example settings illustrated in FIG. 3, since “u1A1” is set, the controller 15 specifies “u1A1” as the account to use in the utilization of the service.

In the case in which a priority account is not set, for example, the usage history information may be referenced to specify one automatically. For example, the account that the user A uses the most is specified. Alternatively, the account used most recently is specified. However, with the above methods of specification, since there is a higher probability of being biased toward one account, the user A may be informed of the registration of information about multiple accounts with the designated service, and the user A may be prompted to designate which account to use this time in the utilization of the service from among the multiple accounts.

With the above arrangement, when the service to use and the account to use are specified, the controller 15 requests the provision of the service by the specified account from the service to use (step 107). The above is the basic process.

Meanwhile, in some cases, an account for the service “SA” specified from the voice of the user is not registered in the user management information, because of an omission in the registration of the user management information, incorrect voice recognition (for example, recognition of a service “SK”) by the smart speaker 1, or the like. In this case (step 104, N), the controller 15 specifies the service to be used by the user as follows.

For example, when “I want to buy water” recognized as the request of the user A is analyzed, from “I want to buy”, it is understood that the user A is expressing a request to purchase a product (water). In other words, since the user wishes to make a purchase, the type of service the user A wants to use may be derived to be “E-commerce”. Consequently, even if user management information for the user A with respect to the service “SA” exemplified in FIG. 3 hypothetically is not registered, the controller 15 specifies the service “SB” of the same type as the service “SA”, that is, a service for which the service type “E-commerce” is set, as a usable service.

In this way, even if the user does not designate a desired service to use, it is possible to specify a service to use from other information included in the voice (step 109).

In other words, the service name “SA” obtained correctly from the voice of the user A is a service name, and thus is information that may be used to specify a service directly, but as described above, since the service type may be specified from “I want to buy water”, and the service “SB” may be derived from the service type, the voice “I want to buy water” is information that may be used to specify the service type. Additionally, the voice “I want to buy water” may act as information that may be used to specify a service indirectly.

Assuming that the request of the user A is “I want to buy water”, even if the service from which the water is purchased is “SB”, it is still possible to fulfill the request of the user A. In this way, in the case in which the voice includes information that may be used to specify a service that the user wants to use (“SA” or “I want to buy water”), the controller 15 is able to specify a service (“SA” or “SB”) capable of fulfilling the user's request on the basis of information that may be used to specify a service.

Also, in the hypothetical case in which the recognized request of the user A is “I want to buy water from a cheap website”, similarly to the above, it is possible to derive that the user A wants to purchase a product (water), and the type of service that the user A wants to use is “e-commerce”. With regard to the user A, “SA” and “SB” are registered as services of the “e-commerce” service type, and from “cheap” included in the request, the controller 15 specifies the service “SB” for which the characteristic “cheap” is set in the user management information as a usable service.

Even when the voice says “cheap”, it is similarly possible to specify the service type from “I want to buy water”, and derive the service “SB” with the characteristic “cheap” from among the services applicable to the specified service type. In other words, the voice “cheap” may act as information that may be used to specify a service indirectly.

Note that, for the sake of simplicity, the above describes as an example a case in which a term that completely matches the term “cheap” included in the voice is set in the “Characteristics” field of the user management information, but by using a thesaurus or the like, it is also possible to accommodate cases in which terms such as “inexpensive”, “affordable”, “lowest price” are set in the “Characteristics” field.

Meanwhile, even when a usable service may be specified as above, cases in which multiple services are extracted may still be anticipated. In such cases, the controller 15 specifies the service to use in the fulfillment of the request of the user A as follows.

For example, the controller 15 references the usage history information for the user A to specify a single service. For example, the service that the user A uses the most is specified. Alternatively, the service used most recently is specified. Alternatively, the user is queried and prompted to select the service that the user wants to use.

With the above arrangement, a service to use may be specified, but there is a possibility that multiple accounts may be registered with the specified service. In the case in which information about multiple accounts is set (step 105, Y), the controller 15 specifies the account to use in the utilization of the service from among the set information about multiple accounts (step 106). Since this process is described above, a description will be omitted. Also, even in the case in which information about only a single account is set (step 105, N), the subsequent process is the same as the above, and thus a description will be omitted.

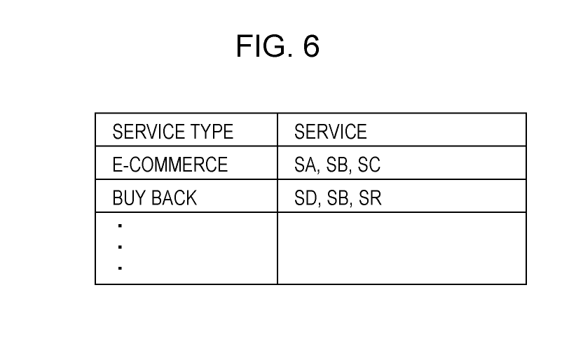

Additionally, in the case in which a usable service is not registered in the user management information (step 108, N), the user A is informed of the situation (step 110). In this case, account registration may be recommended to the user A. Specifically, in the case in which an account is not registered with the service “SA” even though the user A has specified the service “SA”, the controller 15 recommends the registration of an account with the service “SA”. In the case in which the user A has not specified a service, the controller 15 responds with one or multiple services corresponding to the service type applicable to the user's request. For example, the smart speaker 1 internally stores the table illustrated in FIG. 6, and when a service type is specified from the user's voice, one or multiple services from among the services corresponding to the applicable service type are presented as registration candidates.

The user A registers an account with a desired service in accordance with the response, and once again issues a voiced instruction to the smart speaker 1.

As described above, according to the present exemplary embodiment, a service may be specified from content spoken by the user to the smart speaker 1, authentication may be controlled to log in to the specified service using an account of the user. Hypothetically, in the case in which the user has registered multiple accounts with the specified service, authentication may be controlled to log in with a desired account set as a priority account.

Note that in the present exemplary embodiment, the user who wants to use a service is specified by performing voiceprint authentication, but if the smart speaker is provided with an imaging device such as a camera, facial authentication may be performed using video. In addition, if the smart speaker is provided with an operating unit such as a touch panel, the user may also be prompted to input account information.

Additionally, in the present exemplary embodiment, account information is set in advance in the user management information, and when the user issues a voiced instruction to use a service, the account information is acquired from the user management information. However, the user may also be queried for account information to use in the utilization of a service every time a voiced instruction to use a service is given.

Also, the present exemplary embodiment describes the smart speaker 1 provided with an information processing device as an example, but is not limited to the smart speaker 1. For example, the present technology is also applicable to an image forming device such as a multi-function device provided with an information processing device and including a voice recognition function.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a controller that controls an authentication of an account with a service capable of fulfilling a request of a user, the request being specifiable from a received voice of the user.

2. The information processing device according to claim 1, wherein
in a case in which the voice includes information that may be used to specify a service that the user wants to use, the controller specifies the service capable of fulfilling the request of the user on a basis of the information that may be used to specify a service.

3. The information processing device according to claim 2, wherein
the information that may be used to specify a service is a name of the service that the user wants to use.

4. The information processing device according to claim 2, wherein
the information that may be used to specify a service is information that may be used to specify a type of the service that the user wants to use.

5. The information processing device according to claim 1, wherein
in a case in which a plurality of accounts exist for the service capable of fulfilling the request of the user, the controller executes a process of specifying an account for the service to use to fulfill the request of the user.

6. The information processing device according to claim 4, wherein
in a case in which a plurality of accounts exist for the service capable of fulfilling the request of the user, the controller executes a process of specifying an account for the service to use to fulfill the request of the user.

7. The information processing device according to claim 5, wherein
the controller specifies an account for the service to use to fulfill the request of the user by querying the user.

8. The information processing device according to claim 5, wherein
in a case in which the user has registered accounts with a plurality of services, the controller specifies an account for the service to use to fulfill the request of the user on a basis of a past service usage history of the user.

9. The information processing device according to claim 5, wherein
in a case in which the user has registered accounts with a plurality of services, the controller specifies an account for the service to use to fulfill the request of the user on a basis of characteristics of the plurality of services.

10. The information processing device according to claim 2, wherein
in a case of not confirming an account used to execute a service specified on a basis of the information that may be used to specify a service that the user wants to use, the controller informs the user of a service which is of the same type as the specified service and with which the user has already registered an account.

11. The information processing device according to claim 1, wherein
in a case of not confirming an account used to execute a service capable of fulfilling the request of the user, the controller informs the user that an account has not been confirmed.

12. The information processing device according to claim 10, wherein
the controller informs the user in a manner that encourages the user to register an account with a service capable of fulfilling the request of the user.

13. A non-transitory computer readable medium storing a program causing a computer to execute a process for processing information, the process comprising:
controlling an authentication of an account with a service capable of fulfilling a request of a user, the request being specifiable from a received voice of the user.

14. An information processing device comprising:
controller means for controlling an authentication of an account with a service capable of fulfilling a request of a user, the request being specifiable from a received voice of the user.
